(19) United States
(12) Patent Application Publication
(10) Pub. No.: US 2017/0139750 A1
(43) Pub. Date: May 18, 2017

(54) INFORMATION PROCESSING APPARATUS AND COMPILATION METHOD

(71) Applicant: FUJITSU LIMITED, Kawasaki-shi (JP)

(72) Inventor: Yuya FUJII, Numazu (JP)

(73) Assignee: FUJITSU LIMITED, Kawasaki-shi (JP)

(21) Appl. No.: 15/293,780

(22) Filed: Oct. 14, 2016

(30) Foreign Application Priority Data
Nov. 12, 2015 (JP) 2015-221824

(51) Int. Cl. G06F 9/50; G06F 9/48; G06F 9/45

(52) U.S. Cl. CPC G06F 9/5016; G06F 8/41; G06F 9/4843

(57) ABSTRACT

An apparatus includes one or more memories; and one or more processors configured to be coupled to the one or more memories, wherein the one or more processors are configured to generate, through compiling a source code, an object program, execute the object program as multiple processes generated by execution of the object program, allocate a first storage domain in the one or more memories for each of the multiple processes, allocate a variable in the first storage domain for each of the multiple processes, notify multiple processes other than own process of address information of a content of the variable for each of the multiple processes.

### CROSS-REFERENCE TO RELATED APPLICATION

This application is based upon and claims the benefit of priority of the prior Japanese Patent Application No. 2015-221824, filed on Nov. 12, 2015, the entire contents of which are incorporated herein by reference.

### FIELD

The embodiment discussed herein is related to an information processing apparatus and a compilation method.

### BACKGROUND

For example, a service provider (hereinafter, will also be referred to simply as a service provider) that provides users with service establishes a business system in accordance with the purpose and operates the business system in order to provide the users with various types of service.

In such a business system, in order to make the service provided for the users prompt, for example, there are cases where the service provider executes the same processing in parallel or concurrent. Specifically, the business system compiles a source program (hereinafter, will also be referred to as a source code) which is postulated in advance so as to be executed in parallel or concurrent, and the business system generates an object program (hereinafter, will also be referred to simply as an object). The object program is also called as an executable program. Thereafter, the business system executes the generated object multiple times at predetermined times. Accordingly, the business system can execute processing corresponding to the object, in parallel or concurrent.

In addition, a memory domain for storing a value stored in a variable described in the source code is allocated to each process which is generated when the business system executes the object. In this case, for example, the memory domain (hereinafter, will also be referred to as a shared memory domain) at a position which can be referred to by a different process is allocated to each process. In each process, the shared memory domain stores the value stored in each variable, in response to execution of the object. Accordingly, each process can share the value stored in the variable in each process (for example, refer to Japanese Laid-open Patent Publication No. 8-030569 and Japanese Patent No. 4784842).

In the business system described above, in a case where processes are executed by physical machines different from each other, each process desirably performs communication with a different physical machine when referring to a shared memory domain which is allocated to a different process. Accordingly, in this case, the desired time for communication with respect to the different process is lengthened compared to a case where the different process is executed in the same physical machine.

Moreover, in a case where an address at which a variable in each process is stored (an address in the shared memory domain) is determined when an object is executed, there are cases where each process desirably performs communication multiple times with a physical machine in which a different process is operated, in order to acquire a value stored in the variable of the different process. Accordingly, in this case, the desired time for communication between each process and the different process is further lengthened.

### SUMMARY

According to an aspect of the embodiments, an apparatus includes one or more memories; and one or more processors configured to be coupled to the one or more memories, wherein the one or more processors are configured to generate, through compiling a source code, an object program, execute the object program as multiple processes generated by execution of the object program, allocate a first storage domain in the one or more memories for each of the multiple processes, allocate a variable in the first storage domain for each of the multiple processes, notify multiple processes other than own process of address information of a content of the variable for each of the multiple processes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating the overall configuration of an information processing system;

FIG. 2 is a specific example of source codes stored in a storage device;

FIG. 3 is a view describing a specific example of a shared memory domain allocated to variables having no ALLOCATABLE attribute;

FIG. 4 is a view describing a specific example of a shared memory domain allocated to variables having an ALLOCATABLE attribute;

FIG. 5 is a view describing a shared memory domain of a physical machine, according to the present embodiment;

FIG. 6 is a view describing hardware configurations of the physical machines;

FIG. 7 is a view describing information stored in an information storage domain;

FIG. 8 is a functional block diagram of the physical machine in FIG. 6;

FIG. 9 is a functional block diagram of the physical machine in FIG. 6;

FIG. 10 is a flow chart describing the outline of object generation processing, according to a first embodiment;

FIG. 11 is a view describing a case where an object generated through processing of S2 is executed;

FIG. 12 is a flow chart describing the details of the object generation processing, according to the first embodiment;

FIG. 13 is a flow chart describing the details of the object generation processing, according to the first embodiment;

FIG. 14 is a flow chart describing the details of the object generation processing, according to the first embodiment;

FIG. 15 is a flow chart describing the details of the object generation processing, according to the first embodiment;

FIG. 16 is a flow chart describing the details of the object generation processing, according to the first embodiment;

FIG. 17 is a flow chart describing the details of the object generation processing, according to the first embodiment;

FIG. 18 is a flow chart describing the details of the object generation processing, according to the first embodiment;

FIG. 19 is a flow chart describing the details of the object generation processing, according to the first embodiment;

FIG. 20 is a flow chart describing the details of the object generation processing, according to the first embodiment;

FIG. 21 is a view describing a specific example of ID allocation information;

FIG. 22 is a view describing a specific example of ID width information;

FIG. 23 is a view describing a specific example of the ID width information;

FIG. 24 is a view describing a specific example of the ID width information;

FIG. 25 is a view describing a specific example of ID allocation number information;

FIG. 26 is a view describing a specific example of the ID allocation information;

FIG. 27 is a view describing a specific example of the ID allocation number information;

FIG. 28 is a view describing a specific example of the ID allocation information;

FIG. 29 is a view describing a specific example of the ID allocation number information;

FIG. 30 is a view describing a specific example of the ID allocation information;

FIG. 31 is a view describing a specific example of address information prepared when the object is executed;

FIG. 32 is a view describing a specific example of address position information prepared when the object is executed; and

FIG. 33 is a flow chart describing object execution processing, according to the first embodiment.

### DESCRIPTION OF EMBODIMENT

Configuration of Information Processing System

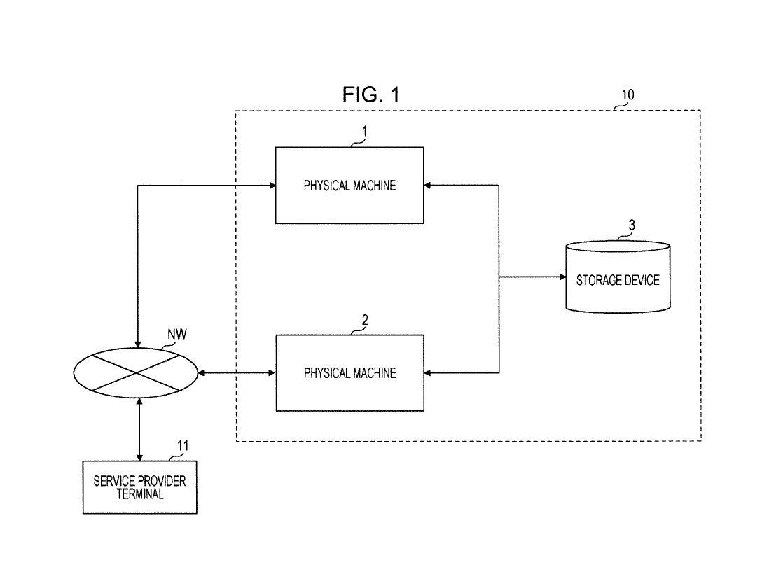

FIG. 1 is a view illustrating the overall configuration of an information processing system 10. The information processing system 10 illustrated in FIG. 1 (hereinafter, will also be referred to as a business system 10) has a physical machine 1 (hereinafter, will also be referred to as an information processing apparatus 1 or a computer 1), a physical machine 2, and a storage device 3. The storage device includes at least one selected from a hard disk drive (HDD), a solid state drive (SSD), a flash memory, and the like. The physical machines 1 and 2 illustrated in FIG. 1 can have access to a service provider terminal 11 via a network NW such as the Internet network.

The physical machines 1 and 2 execute processing for providing users with service. For example, in order to disperse the load entailed by execution of the processing, the physical machines 1 and 2 execute the same object.

For example, the storage device 3 stores objects for providing users with service, source codes, and compilation programs (hereinafter, will also be referred to as compilers). For example, when the object is executed, the physical machines 1 and 2 acquire the object from the storage device 3 and execute the acquired object.

The service provider terminal 11 is a terminal through which a service provider performs management of the physical machines 1 and 2, and the storage device 3. Specifically, for example, the service provider instructs each physical machine to generate the object, via the service provider terminal 11. In addition, for example, the service provider instructs each physical machine to execute the object, via the service provider terminal 11.

The information processing system 10 illustrated in FIG. 1 has the physical machine 1 and the physical machine 2. However, the information processing system 10 may be configured to have three or more physical machines.

Specific Example of Source Code

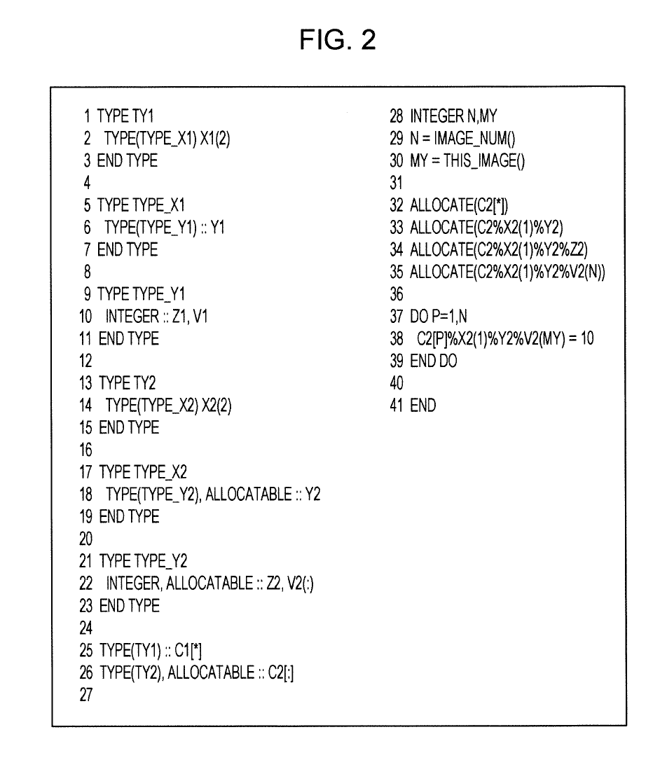

FIG. 2 is a specific example of the source codes stored in the storage device 3. Specifically, the source codes illustrated in FIG. 2 are source codes described by using “Fortran 2008”. In the example illustrated in FIG. 2, line numbers are described on the left side of the source codes.

In the example illustrated in FIG. 2, “TYPE TY1” in the first line, “TYPE(TYPE_X1)X1(2)” in the second line, and “END TYPE” in the third line define derived-type TY1 which has a TYPE_X1-type array component X1 including two elements.

In addition, in the example illustrated in FIG. 2, “TYPE TYPE_X1” in the fifth line, “TYPE(TYPE_Y1)::Y1” in the sixth line, and “END TYPE” in the seventh line define derived-type TYPE_X1 which has a TYPE_Y1-type component Y1.

In addition, in the example illustrated in FIG. 2, “TYPE TYPE_Y1” in the ninth line, “INTEGER::Z1,V1” in the 10th line, and “END TYPE” in the 11th line define derived-type TYPE_Y1 which has a component Z1 and a component V1.

In addition, in the example illustrated in FIG. 2, “TYPE TY2” in the 13th line, “TYPE(TYPE_X2)X2(2)” in the 14th line, and “END TYPE” in the 15th line define derived-type TY2 which has a TYPE_X2-type array component X2 including two elements.

In addition, in the example illustrated in FIG. 2, “TYPE TYPE_X2” in the 17th line, “TYPE(TYPE_Y2),ALLOCATABLE::Y2” in the 18th line, and “END TYPE” in the 19th line define derived-type TYPE_X2 which has a TYPE_Y2-type component Y2. The 18th line in the example illustrated in FIG. 2 defines that a memory domain (a storage domain) of the component Y2 is determined when the object is executed.

In addition, in the example illustrated in FIG. 2, “TYPE TYPE_Y1” in the 21st line, “INTEGER,ALLOCATABLE::Z2,V2(:)” in the 22nd line, and “END TYPE” in the 23rd line define derived-type TYPE_Y2 which has a component Z2 and an array component V2. The 22nd line in the example illustrated in FIG. 2 defines that memory domains of the component Z2 and the array component V2 are determined when the object is executed.

In addition, in the example illustrated in FIG. 2, “TYPE(TY1)::C1[*]” in the 25th line and “TYPE(TY2),ALLOCATABLE::C2[:]” in the 26th line respectively define a TY1-type coarray (an array referred to by a different process) C1 and a TY2-type coarray C2. The 26th line in the example illustrated in FIG. 2 defines that a memory domain of the coarray C2 is determined when the object is executed.

In addition, in the example illustrated in FIG. 2, “INTEGER N,MY” in the 28th line, “N=IMAGE_NUM( )” in the 29th line, and “MY=THIS_IMAGE( )” in the 30th line defined that a return value of a function IMAGE_NUM( ) is stored in a variable N, and a return value of a function THIS_IMAGE( ) is stored in a variable MY.

In addition, in the example illustrated in FIG. 2, “ALLOCATE(C2[*])” in the 32nd line and “ALLOCATE(C2%X2(1)%Y2)” in the 33rd line define that a shared memory domain of the coarray C2 and the variable Y2 (the component of the first element in the array X2) is ensured when the object is executed. In addition, in the example illustrated in FIG. 2, “ALLOCATE(C2%X2(1)%Y2%Z2)” in the 34th line defines that a shared memory domain of the variable Z2 is ensured when the object is executed. Moreover, in the example illustrated in FIG. 2, “ALLOCATE(C2%X2(1)%Y2%V2(N))” in the 35th line defines that a shared memory domain corresponding to each of the N elements of the array component V2 is ensured.

In addition, in the example illustrated in FIG. 2, “DO P=1,N” in the 37th line, “C2[P]%X2(1)%Y2%V2(MY)=10” in the 38th line, and “END DO” in the 39th line define that “10” is stored in the MYth element of the array V2 until P which is the identification number of the process changes from 1 to N.

In other words, the source codes illustrated in FIG. 2 are source codes describing processing in which “10” is stored in the shared memory domain corresponding to the MYth element of the array component V2 in the shared memory domain allocated to each of the N processes.

Specific Example of Memory Domain Allocated to Variable Having No ALLOCATABLE Attribute

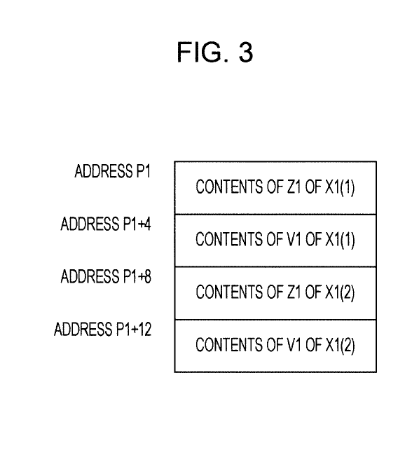

Next, description will be given regarding a specific example of a shared memory domain which is allocated to a variable having no ALLOCATABLE attribute (a variable of which the address does not change during the operation of the process). FIG. 3 is a view describing the specific example of the shared memory domain which is allocated to the variable having no ALLOCATABLE attribute. Hereinafter, description will be given on the assumption that each process is generated by executing each object in which the source code illustrated in FIG. 2 is compiled.

In the source codes illustrated in FIG. 2, the variable Z1 and the variable V1 are not defined as variables having an ALLOCATABLE attribute (the 10th line in FIG. 2). Accordingly, the shared memory domain allocated to the variable Z1 and the variable V1 is determined when the source code illustrated in FIG. 2 is compiled.

Specifically, in the example illustrated in FIG. 3, for example, the compiler allocates an address P1 as the shared memory domain of the variable Z1 which can be traced from the first element of the array X1, and allocates an address P1+4 as the shared memory domain of the variable V1 which can be traced from the first element of the array X1. In addition, in the example illustrated in FIG. 3, for example, the compiler allocates an address P1+8 as the shared memory domain of the variable Z1 which can be traced from the second element of the array X1, and allocates an address P1+12 as the shared memory domain of the variable V1 which can be traced from the second element of the array X1. Accordingly, in a case of having access to the contents of the variable Z1 of a different process or the variable V1, each process can have access to desired information by referring to the address of the contents of each variable (the address P1, the address P1+4, the address P1+8, and the address P1+12). In other words, in this case, each process can have access to the variable Z1 of a different process or the variable V1 by having access to the shared memory domain allocated to the different process, only once.

Specific Example of Memory Domain Allocated to Variable Having ALLOCATABLE Attribute

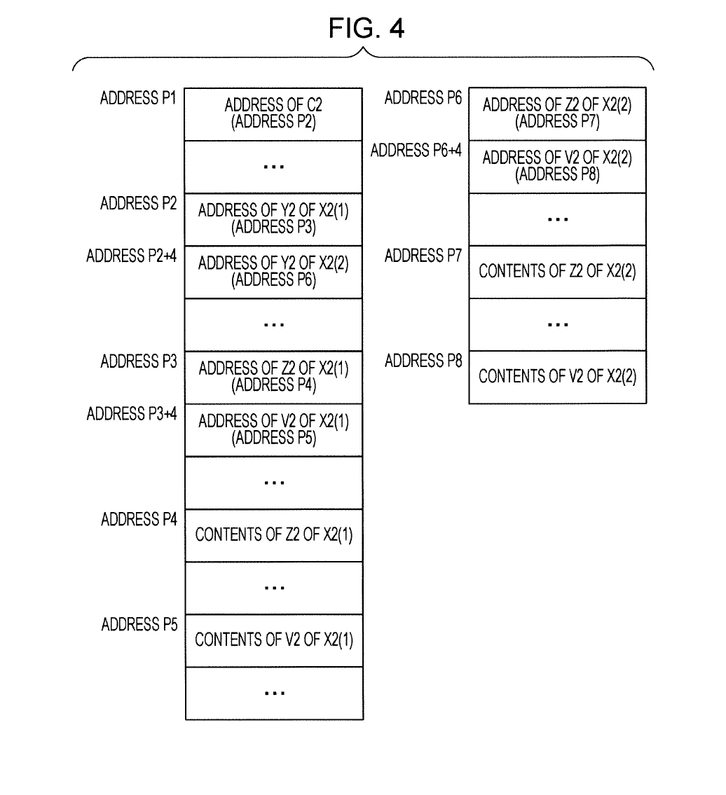

Next, description will be given regarding a specific example of a memory domain which is allocated to a variable having an ALLOCATABLE attribute (a variable of which the address changes during the operation of the process). FIG. 4 is a view describing the specific example of the shared memory domain which is allocated to the variable having an ALLOCATABLE attribute.

In the source code illustrated in FIG. 2, the variable Z2 and the array V2 are defined as variables having an ALLOCATABLE attribute (the 22nd line in FIG. 2). Accordingly, the shared memory domain allocated to the variable Z2 and the array V2 is determined when the object generated based on the source code illustrated in FIG. 2 is executed.

In this case, when the object is generated, for example, the compiler allocates the memory domain which stores the address of the shared memory domain of the variables, in addition to the shared memory domain which stores the contents of the variable Z2 and the array V2 are stored. Specifically, as illustrated in FIG. 4, the compiler allocates the shared memory domain (the address P1, the address P2, the address P2+4, the address P3, the address P3+4, the address P6, and the address P6+4 in FIG. 4) which stores the addresses of the coarray C2, the variable Y2, the variable Z2, and the array V2, in addition to the shared memory domain which stores the contents of the variable Z2 and the array V2 (the address P6 and the address P7 in FIG. 4).

For example, in a case of having access to the variable Z2 which can be traced from the first element of the array X2 of a different process, each process acquires the address (the address P2) of the coarray C2 by having access to the address P1, and acquires the address (the address P3) of the variable Y2 which is a component of the first element of the array X2 by having access to the address P2. Thereafter, each process acquires the address (the address P4) of the variable Z2 which is a component of the variable Y2 by having access to the address P3, and acquires the contents of the variable Z2 by having access to the address P4.

Here, in a case where the processes are executed by the physical machines different from each other, each process desirably has access to a different physical machine when referring to the shared memory domain of a different process. Accordingly, in this case, the desired time for communication with respect to the different process is lengthened compared to a case where the different process is executed in the same physical machine.

Moreover, there are cases where the address of a variable in the shared memory domain of each process is determined when the object is executed, as described in FIG. 4. Accordingly, in this case, each process desirably has access to the shared memory domain of a different physical machine multiple times until the process has access to the variable of the different process.

Therefore, the physical machine 1 according to the present embodiment generates an object such that address information of a variable subjected to communication among the processes, that is, a variable (hereinafter, will also be referred to as a first variable) to which a memory domain (a shared memory domain) is designated at the time of execution of the object is notified so as to be shared with a different physical machine (for example, the physical machine 2) when the object is executed. Hereinafter, the shared memory domain of the physical machine 1 according to the present embodiment will be described.

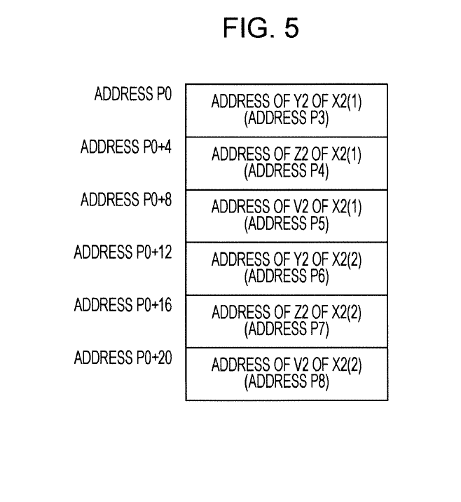

FIG. 5 is a view describing a shared memory domain of the physical machine 1, according to the present embodiment. As illustrated in FIG. 5, the physical machine 1 according to the present embodiment allocates a memory domain which stores an address allowing direct access, with respect to the variable subjected to communication in the processes, that is, the first variable to which a storage domain (hereinafter, will also be referred to as a first storage domain) is allocated when the object is executed, in addition to the memory domain described in FIG. 4. Specifically, as illustrated in FIG. 5, when the object is executed, the physical machine 1 generates an object such that the address of the variable Y2 which can be traced from the first element of the array X2, the address of the variable Z2, and the address of the array V2 are respectively stored in the memory domains of the address P0, the address P0+4, and the address P0+8; and the address of the variable Y2 which can be traced from the second element of the array X2, the address of the variable Z2, and the address of the array V2 are respectively stored in the memory domains of the address P0+12, the address P0+16, and the address P0+20. In the physical machine 1 according to the present embodiment, the address information of the first variable is notified so as to be shared with a different process (for example, the process operated by the physical machine 2).

Accordingly, even in a case where a different process to be subjected to access is present in a different physical machine, the physical machine 1 can reduce the desired number of times of communication for access to the variable of the different process. Accordingly, the physical machine 1 can shorten the desired time for execution of the object.

Hardware Configuration of Physical Machine

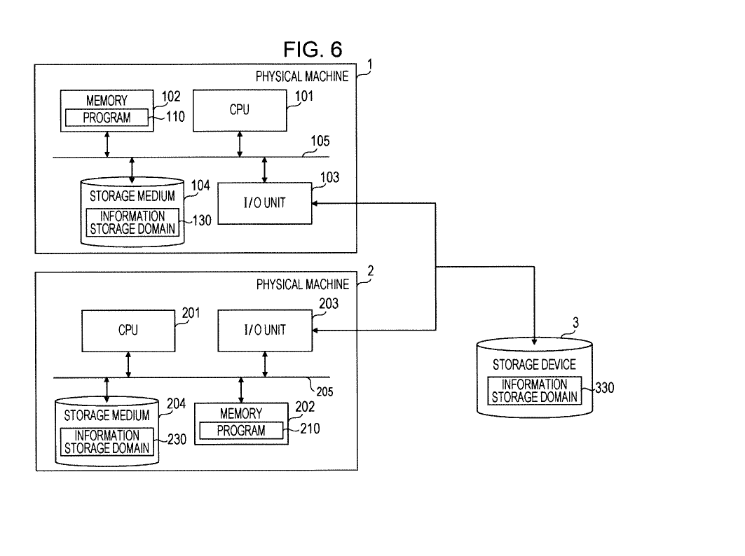

Next, hardware configurations of the physical machines 1 and 2 will be described. FIG. 6 is a view describing the hardware configurations of the physical machines 1 and 2.

The physical machine 1 includes a CPU 101 which has one, two, or more processors, a memory 102, an external interface (an I/O unit) 103, and a storage medium (a storage) 104. The units are connected to each other via a bus 105.

The storage medium 104 stores a program 110 (hereinafter, will also be referred to as an object generating program 110) for performing processing (hereinafter, will also be referred to as object generation processing) in which an object is generated, in a program storage domain in the storage medium 104. As a non-volatile storage medium, the storage medium 104 includes at least one selected from a read only memory (ROM), a hard disk drive (HDD), a solid state drive (SSD), an electrically erasable programmable read-only memory (EEPROM), a flash memory, and the like. The non-volatile storage medium stores an OS or various types of application programs, and data used when the programs are executed. In addition, for example, the storage medium 104 has an information storage domain 130 (hereinafter, will also be referred to as a storage section 130) which stores information used when the object generation processing is performed.

As illustrated in FIG. 6, when the program 110 is executed, the CPU 101 loads the program 110 from the storage medium 104 to the memory 102 and performs the object generation processing in association with the program 110. In addition, the external interface 103 performs communication with the physical machine 1 or the storage device 3. The external interface 103 may also perform communication with the physical machine 1 or the storage device 3 via the bus 105.

The physical machine 2 includes a CPU 201 which has one, two, or more processors, a memory 202, an external interface (an I/O unit) 203, and a storage medium (a storage) 204. The units are connected to each other via a bus 205.

The storage medium 204 stores an object generating program 210 for performing the object generation processing, in the program storage domain in the storage medium 204. As a non-volatile storage medium, the storage medium 204 includes at least one selected from a read only memory (ROM), a hard disk drive (HDD), a solid state drive (SSD), an electrically erasable programmable read-only memory (EEPROM), a flash memory, and the like. The non-volatile storage medium stores an OS or various types of application programs, and data used when the programs are executed. In addition, for example, the storage medium 204 has an information storage domain 230 (hereinafter, will also be referred to as a storage section 230) which stores information used when the object generation processing is performed.

As illustrated in FIG. 6, when the program 210 is executed, the CPU 201 loads the program 210 from the storage medium 204 to the memory 202 and performs the object generation processing in association with the program 210. In addition, the external interface 203 performs communication with the physical machine 2 or the storage device 3. The external interface 203 may also perform communication with the physical machine 2 or the storage device 3 via the bus 205.

As a non-volatile storage medium, the storage device 3 includes at least one selected from a read only memory (ROM), a hard disk drive (HDD), a solid state drive (SSD), an electrically erasable programmable read-only memory (EEPROM), a flash memory, and the like. The non-volatile storage medium may store an OS or various types of application programs, and data used when the programs are executed. The storage device 3 has an information storage domain 330 (hereinafter, will also be referred to as a storage section 330) configured to store desired information for the CPU 101 of the physical machine 1 or the CPU 201 of the physical machine 2 which execute the object generation processing. Hereinafter, information stored in the information storage domain 330 will be described.

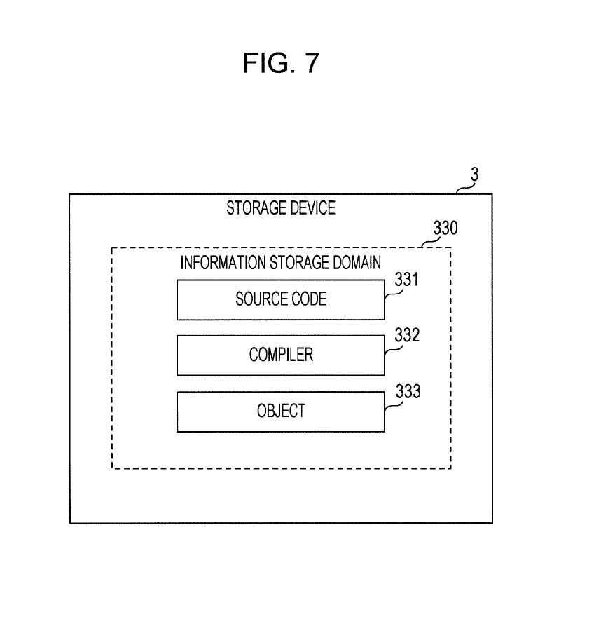

FIG. 7 is a view describing the information stored in the information storage domain 330. For example, as illustrated in FIG. 7, the information storage domain 330 stores a source code 331, a compiler 332 which compiles the source code 331, and an object 333 which is generated when the compiler 332 compiles the source code 331. In other words, for example, the information storage domain 330 stores desired information (information shared between the physical machine 1 and the physical machine 2) for each of the CPU 101 and the CPU 201 which execute the object generation processing.

Software Configuration of Physical Machine

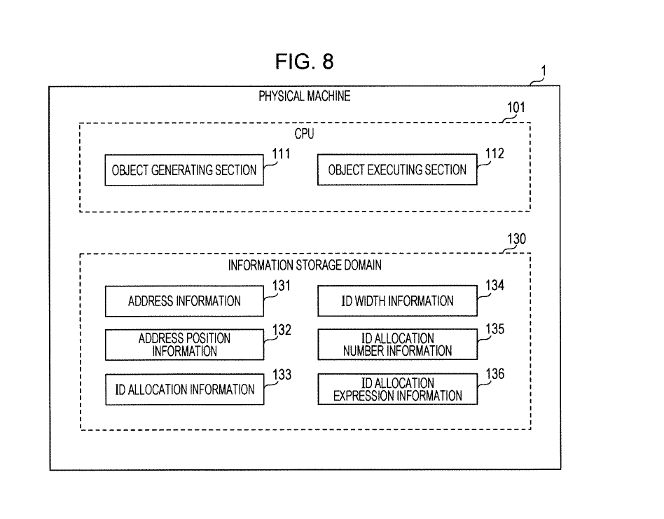

Next, software configurations of the physical machines 1 and 2 will be described. FIG. 8 is a functional block diagram of the physical machine 1 in FIG. 6. The CPU 101 operates as an object generating section 111 and an object executing section 112 in association with the program 110. In addition, the information storage domain 130 stores address information 131, address position information 132, ID allocation information 133, ID width information 134, ID allocation number information 135, and ID allocation expression information 136.

The object generating section 111 acquires the source code 331 and the compiler 332 stored in the information storage domain 330. The object generating section 111 generates the object 333 when the compiler 332 compiles the source code 331. Thereafter, the object generating section 111 stores the generated object 333 in the information storage domain 330.

Specifically, the object generating section 111 generates the object 333 such that the address information 131 of the first storage domain of a variable subjected to communication in multiple processes generated in response to execution of the same object 333, that is, the first variable to which the storage domain is allocated in response to execution of the object 333 is notified so as to be shared in the multiple processes when the object 333 is executed.

For example, the object generating section 111 may generate the object 333 when information on starting compilation of a predetermined source code 331 is received from the service provider terminal 11. In addition, the object generating section 111 may be configured to generate the object 333 such that the address position information 132 indicating the address of the storage domain of the address information 131 is notified, instead of the address information 131, when the object 333 is executed.

The object executing section 112 acquires the object 333 stored in the information storage domain 330. The object executing section 112 executes the acquired object 333. In this case, the object executing section 112 issues notification of the address information 131 stored in the first storage domain, in response to execution of the object 333 so as to be shared in the multiple processes generated in response to execution of the object 333. The ID allocation information 133, the ID width information 134, the ID allocation number information 135, and the ID allocation expression information 136 will be described later.

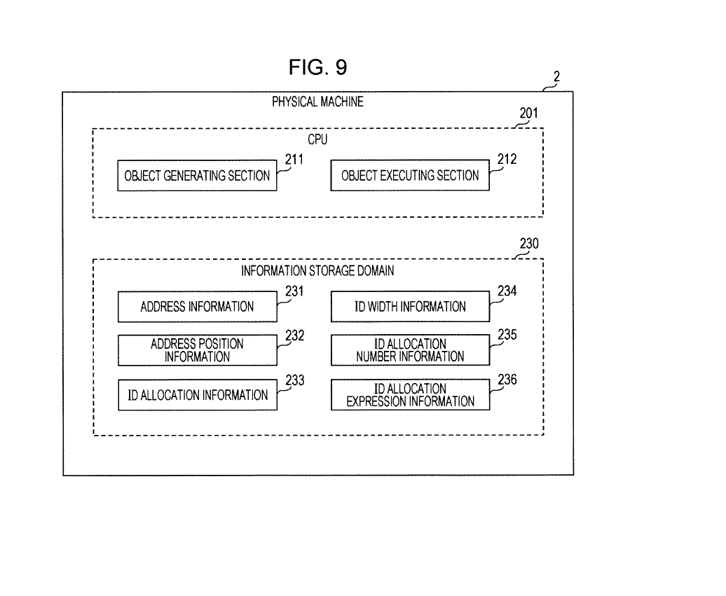

In addition, FIG. 9 is a functional block diagram of the physical machine 2 in FIG. 6. The CPU 201 operates as an object generating section 211 and an object executing section 212 in association with the program 210. In addition, the information storage domain 230 stores address information 231, address position information 232, ID allocation information 233, ID width information 234, ID allocation number information 235, and ID allocation expression information 236.

Operations of the object generating section 211 and the object executing section 212 are the same as the operations of the object generating section 111 and the object executing section 112. Thus, detailed description thereof will be omitted. In addition, the contents of the address information 231, the address position information 232, the ID allocation information 233, and the ID width information 234 are the same as the contents of the address information 131, the address position information 132, the ID allocation information 133, and the ID width information 134. Thus, detailed description thereof will be omitted. Moreover, the contents of the ID allocation number information 235 and the ID allocation expression information 236 are the same as the contents of the ID allocation number information 135 and the ID allocation expression information 136. Thus, detailed description thereof will be omitted.

### Outline of First Embodiment

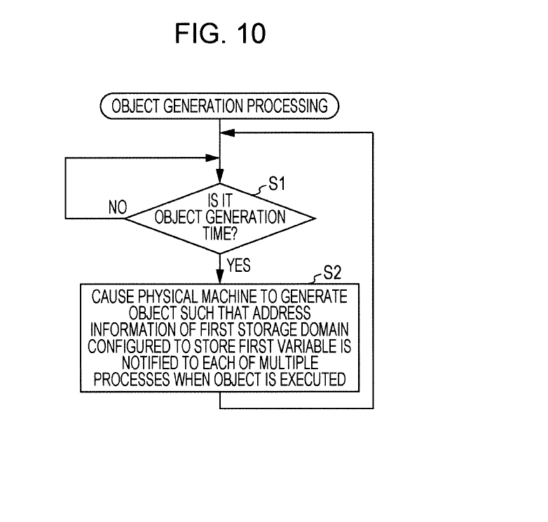

Next, the outline of a first embodiment will be described. FIG. 10 is a flow chart describing the outline of the object generation processing, according to the first embodiment. Hereinafter, description will be given regarding a case where the physical machine 1 executes the object generation processing.

As illustrated in FIG. 10, the physical machine 1 stands by until it is time to generate the object 333 (hereinafter, will also be referred to as an object generation time) (NO in S1). For example, the object generation time may be a time to generate the object 333 in information which is input to the service provider terminal 11. In addition, for example, the object generation time may be a predetermined time interval (for example, every one hour).

In a case where it is the object generation time (YES in S1), the physical machine 1 generates the object 333 when the compiler 332 compiles the source code 331. Specifically, the physical machine 1 generates the object 333 such that the address information 131 of the first storage domain of the first variable is notified so as to be shared in the multiple processes generated in response to execution of the object 333 when the object 333 is executed (S2). Hereinafter, description will be given regarding a case of executing the object generated through the processing of S2.

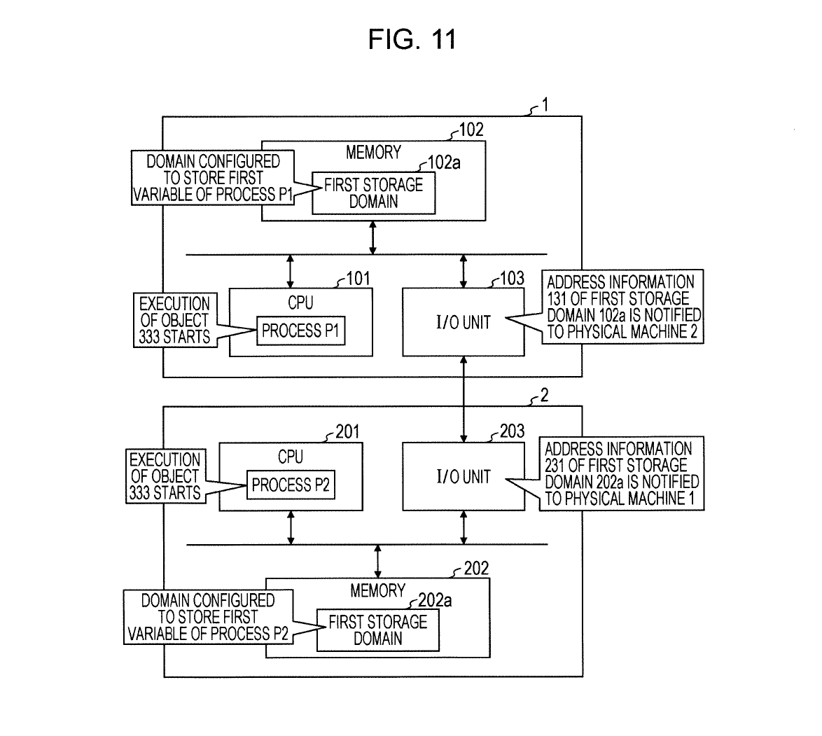

FIG. 11 is a view describing the case of executing the object 333 generated through the processing of S2. The example illustrated in FIG. 11 indicates a state where the object 333 is executed in the CPU 101 and the CPU 201 at the same time. Hereinafter, a process which operates when the object 333 is executed in the CPU 101 will also be referred to as a process P1, and a process which operates when the object 333 is executed in the CPU 201 will also be referred to as a process P2. In other words, the example illustrated in FIG. 11 indicates a state where the process P1 starts to operate in the CPU 101 and the process P2 starts to operate in the CPU 201.

In the example illustrated in FIG. 11, the physical machine 1 (the CPU 101) notifies the physical machine 2 of the address information 131 of a first storage domain 102a configured to store the first variable in the process P1, in response to execution of the object 333 in the physical machine 1. In addition, the physical machine 2 (the CPU 201) notifies the physical machine 1 of the address information 231 of a first storage domain 202a configured to store the first variable in the process P2, in response to execution of the object 333 in the physical machine 2.

Accordingly, for example, the process P1 can refer to the first storage domain 202a in a case of having access to the first variable in the process P2. In this case, the process P1 can have direct access to the first variable in the process P2 by referring to the address information 231 stored in the first storage domain 202a. Accordingly, the physical machine 1 can reduce the number of times of communication with respect to the physical machine 2 entailed by execution of the object 333.

Here, in the example illustrated in FIG. 11, the physical machine 1 can store the first variable in the process P2 (a copy of a second variable in the process P2) in the physical machine 1 (for example, the first storage domain 102a). Accordingly, the physical machine 1 can have access to the first variable in the process P2 without having access to the first storage domain 202a.

However, as in the processing described in the 37th line to the 39th line of the source codes illustrated in FIG. 2, there are cases where a different process to which each process has access varies each term of iteration of loop. In this case, even in a case where the first variable in the process P2 is held in the physical machine 1, the physical machine 1 may not reduce the number of times of communication when having access to the first variable in a different process other than the process P2.

Accordingly, in the physical machine 1 according to the present embodiment, the physical machine 1 does not store the first variable in the process P2. The physical machine 1 stores only the address information 231 of the first variable in the process P2. The physical machine 1 has access to the first variable in the process P2 stored in the first storage domain 202a of the physical machine 2, with reference to the address information 231.

In this manner, the physical machine 1 has the object generating section 111 which generates the object 333 such that the address information of the first storage domain 102a configured to store a variable subjected to communication in the multiple processes generated in response to execution of the object 333, that is, the first variable to which the storage domain is designated in response to execution of the object 333 is notified so as to be shared in the multiple processes when the object 333 is executed.

Accordingly, even in a case where a different process to be subjected to access is present in a different physical machine, the physical machine 1 can reduce the desired number of times of communication for access to the variable of the different process. Accordingly, the physical machine 1 can shorten the desired time for execution of the object.

### Details of First Embodiment

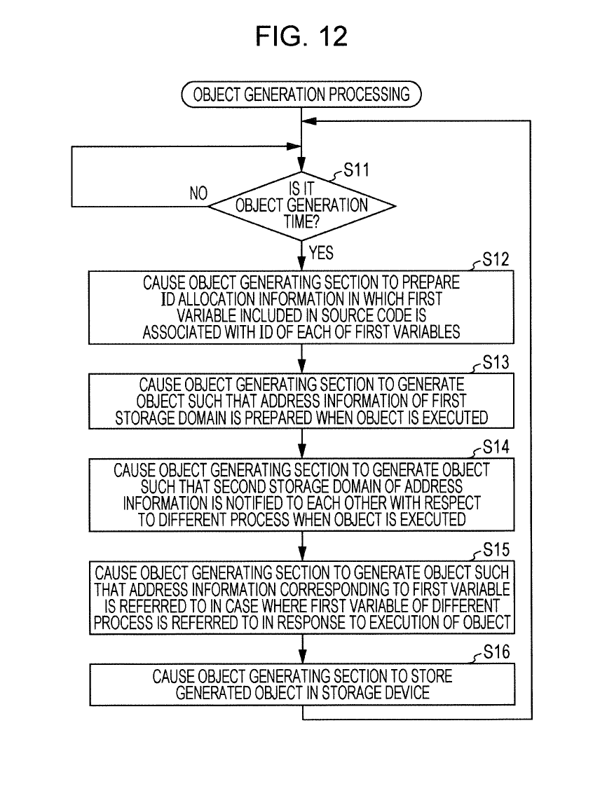

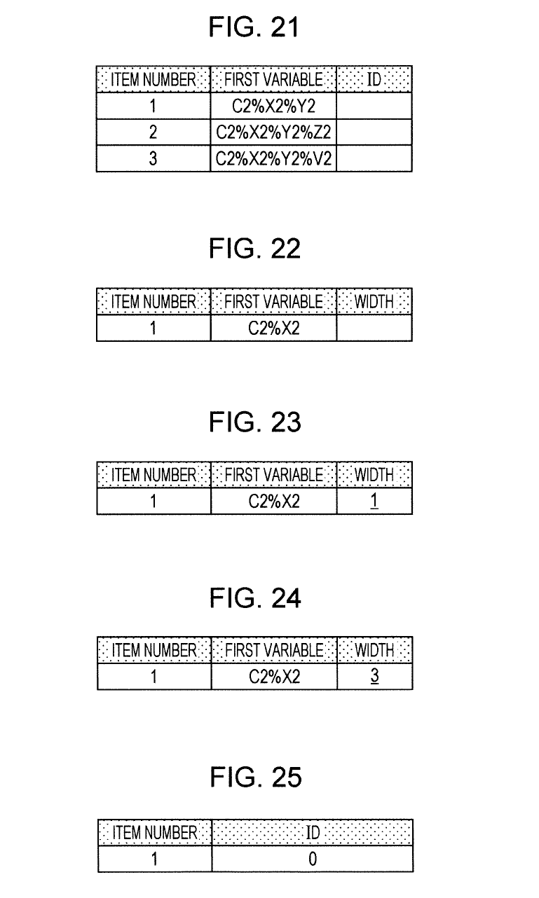

Next, the details of the first embodiment will be described. FIGS. 12 to 20 are flow charts describing the details of the object generation processing, according to the first embodiment. In addition, FIGS. 21 to 32 are views describing the details of the object generation processing, according to the first embodiment. With reference to FIGS. 21 to 32, the object generation processing in FIGS. 12 to 20 will be described. Hereinafter, description will be given regarding a case where the object 333 is generated based on the source code 331 described in FIG. 2.

As illustrated in FIG. 12, the object generating section 111 of the physical machine 1 stands by until it is the object generation time (NO in S11). In a case where it is the object generation time (YES in S11), the object generating section 111 starts to generate the object 333 when the compiler 332 compiles the source code 331. Specifically, first, the object generating section 111 prepares the ID allocation information 133 that is information in which the first variable described in the source code 331, and identification information (hereinafter, will also be referred to simply as ID) for specifying each of the first variables are associated with each other (S12). Hereinafter, the details of the processing of S12 will be described.

Details of Processing of S12

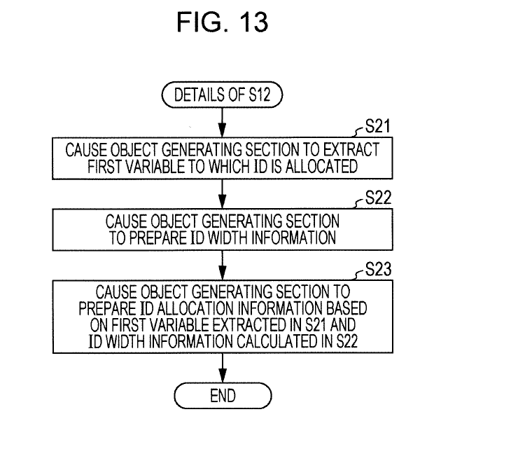

FIG. 13 is a view describing the details of the processing of S12. First, the object generating section 111 extracts a first variable to which ID is allocated, with reference to the source code 331 (S21). In other words, the object generating section 111 extracts a first variable of which the ID allocation information 133 is to be subjected to setting of information. Hereinafter, the details of the processing of S21 will be described.

Details of Processing of S21

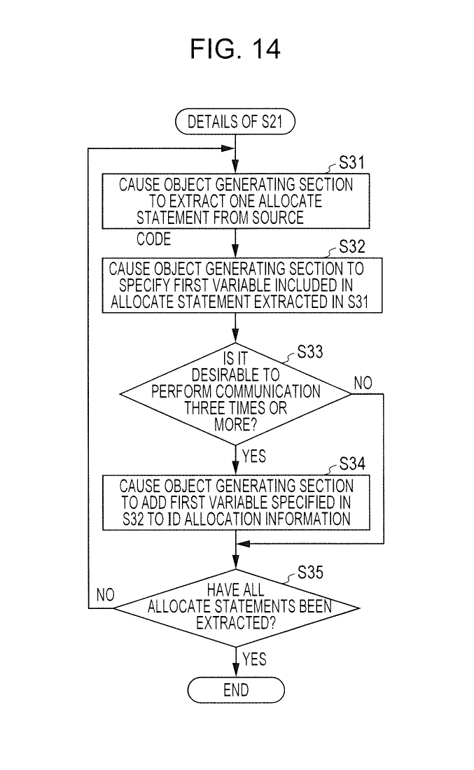

FIG. 14 is a view describing the details of the processing of S21. First, the object generating section 111 extracts one ALLOCATE statement from the source code 331 (S31). The object generating section 111 specifies the first variable included in the ALLOCATE statement extracted through the processing of S31 (S32).

Thereafter, for example, in a case where the first variable specified through the processing of S32 is referred to by a different process, the object generating section 111 determines whether or not the first variable is desired to perform three or more times of communication (S33). As a result thereof, in a case where the first variable is desired to perform three or more times of communication in a case where the first variable is referred to by a different process (YES in S33), the object generating section 111 adds the first variable specified through the processing of S32 to the ID allocation information 133 (S34). Meanwhile, in a case where the first variable is not desired to perform three or more times of communication in a case where the first variable is referred to by a different process (NO in S33), the object generating section 111 does not execute the processing of S34.

Specifically, in the example illustrated in FIG. 4, in a case where a different process has access to the variable Z2 which can be traced from the first element of the array X2, the different process acquires the address (the address P2) of the coarray C2 by having access to the address P1, and acquires the address (the address P3) of the variable Y2 which is a component of the first element of the array X2 by having access to the address P2. Thereafter, the different process acquires the address (the address P4) of the variable Z2 which is a component of the variable Y2 by having access to the address P3, and acquires the contents of the variable Z2 by having access to the address P4. Therefore, in this case, the different process is desired to perform four times of communication in order to have access to the variable Z2 (YES in S33). Accordingly, in a case where the first variable extracted in S32 is the variable Z2, the object generating section 111 executes the processing of S34.

In other words, in the processing of S33 and S34, the object generating section 111 extracts only the first variable of which the number of times of communication in the physical machines can be efficiently reduced, from the source code 331.

Thereafter, the object generating section 111 determines whether or not all of the ALLOCATE statements are extracted from the source code 331 (S35). As a result thereof, in a case where extraction of all of the ALLOCATE statement is completed (YES in S35), the object generating section 111 ends the processing of S21. Meanwhile, in a case where extraction of all of the ALLOCATE statement is not completed (NO in S35), the object generating section 111 executes the processing after S31 again.

In the processing of S33, the object generating section 111 may be configured to execute the processing of S34 only in a case where the first variable specified through the processing in S32 is a variable to which ID can be statically allocated (YES in S33).

In other words, for example, in a case where the first variable extracted through the processing of S32 is an array or the like of which the size is unknown until the object is executed, the object generating section 111 may not specify the number of the first variables desired to be subjected to allocation of ID when the object 333 is generated. Accordingly, regarding the first variable specified through the processing in S32 is a variable to which ID may not be statically allocated, in order to exclude the aforementioned first variable from the first variables to which ID is allocated, the object generating section 111 may be configured not to perform addition with respect to the ID allocation information 133.

Next, a specific example of the processing of S21 will be described.

In the source code 331 illustrated in FIG. 2, the object generating section 111 extracts “ALLOCATE(C2[*])” described in the 32nd line, and specifies the coarray C2 included in the extracted description (S31 and S32). Here, for example, in a case where the process P2 has access to the coarray C2 of the process P1, the process P2 is desired to have access once to the shared memory domain allocated to the process P1 (NO in S33). Accordingly, the object generating section 111 does not add the coarray C2 to the ID allocation information 133.

Thereafter, the object generating section 111 extracts “ALLOCATE(C2%X2(1)%Y2)” described in the 33rd line, and specifies the variable Y2 included in the extracted description (S31 and S32). Here, for example, in a case where the process P2 has access to the coarray C2 of the process P1, the process P2 is desired to have access three times to the shared memory domain allocated to the process P1 (YES in S33). Accordingly, the object generating section 111 adds the variable Y2 to the ID allocation information 133 (S34).

Similarly, the object generating section 111 extracts “ALLOCATE(C2%X2(1)%Y2%Z2)” described in the 34th line, and adds the variable Z2 to the ID allocation information 133 (S34). In addition, the object generating section 111 extracts “ALLOCATE(C2%X2(1)%Y2%V2(N))” described in the 35th line, and adds the array V2 to the ID allocation information 133 (S34). Hereinafter, description will be given regarding a specific example of the ID allocation information 133 in a case where the processing of S21 is executed with respect to the source code 331 illustrated in FIG. 2.

Specific Example of ID Allocation Information

FIGS. 21, 26, 28, and 30 are views describing specific examples of the ID allocation information 133. The ID allocation information 133 illustrated in FIGS. 21, 26, 28, and 30 has “item number” for identifying each piece of information included in the ID allocation information, “first variable” for setting the first variable, and “ID” for setting the identification information (ID) allocated to each of the first variables, as items.

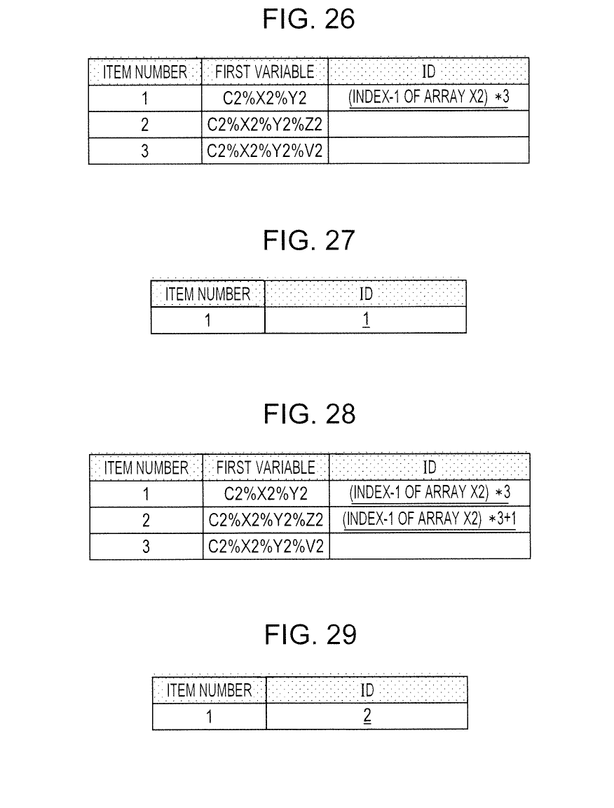

Specifically, FIG. 21 is a view describing a specific example of the ID allocation information 133 in a case where the processing of S21 is executed. In the ID allocation information 133 illustrated in FIG. 21, “C2%X2%Y2” which is “first variable” is set to information of which “item number” is “1”. In the ID allocation information 133 illustrated in FIG. 21, “ID” of the information of which “item number” is “1” is in a blank state. Description of other pieces of information in FIG. 21 will be omitted. In addition, the ID allocation information 133 illustrated in FIGS. 26, 28, and 30 will be described later.

Returning to FIG. 13, the object generating section 111 prepares the ID width information 134 (S22). In a case where the first variable extracted through the processing of S21 is a component of the array, the ID width information 134 is information indicating the number of components (hereinafter, will also be referred to simply as a width) included in the ID allocation information 133 in each of the elements in the array. Hereinafter, the details of the processing of S22 will be described.

Details of Processing of S22

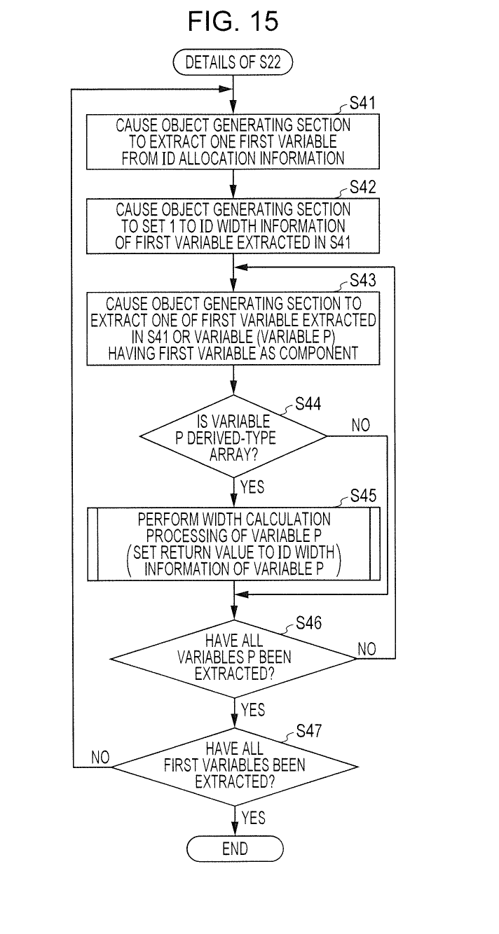

FIG. 15 is a view describing the details of the processing of S22. First, the object generating section 111 extracts one first variable from the ID allocation information 133 (S41). The object generating section 111 sets “1” to the ID width information 134 of the first variable extracted through the processing of S41 (S42). Hereinafter, a specific example of the ID width information 134 will be described.

Specific Example of ID Width Information

FIGS. 22 to 24 are views describing specific examples of the ID width information 134. The ID width information 134 illustrated in FIGS. 22 to 24 has “item number” for identifying each piece of information included in the ID width information 134, “first variable” for setting the first variable, and “width” for setting the width of the first variable, as items.

Specifically, in the ID width information 134 illustrated in FIG. 22, “C2%X2” which is “first variable” is set to information of which “item number” is “1”, and “width” is in a blank state. Description of other pieces of information in FIG. 22 will be omitted.

In a case where the array X2 is extracted through the processing of S41, as indicated by the underlined portion in FIG. 23, the object generating section 111 sets “1” to “width” of information of which “first variable” is “C2%X2” (information of which “item number” is “1”). The ID width information 134 illustrated in FIG. 24 will be described later.

Returning to FIG. 15, the object generating section 111 extracts one of the first variable extracted through the processing of S41 and the variable which has the first variable extracted through the processing of S41 as a component (hereinafter, will also be referred to as a variable P) (S43). In other words, the object generating section 111 extracts an array which has the first variable as a component.

Subsequently, in a case where the variable P is an array having the component (hereinafter, will also be referred to as a derived-type array) (YES in S44), the object generating section 111 executes processing for calculating the width of the variable P (hereinafter, will also be referred to as width calculation processing) (S45). The width calculation processing will be described later. Meanwhile, in a case where the variable P is not the derived-type array (NO in S44), the processing of S45 is not executed.

In a case where extraction of all of the variables P is not completed (NO in S46), the object generating section 111 executes the processing of S43 to S45 again.

Specifically, in a case where the variable Y2 is extracted through the processing of S41, the object generating section 111 extracts the coarray C2 which has the variable Y2 as a component, as the variable P (S43). Here, the coarray C2 is not the derived-type array (NO in S44, and NO in S46). Accordingly, the object generating section 111 does not execute the width calculation processing with respect to the coarray C2. In addition, similar to a case where the variable Y2 itself is extracted as the variable P, the object generating section 111 does not execute the width calculation processing with respect to the variable Y2 (S43, NO in S44, and NO in S46).

Meanwhile, the array X2 which is a variable having the variable Y2 as a component is the derived-type array (S43, and YES in S44). Accordingly, in a case where the array X2 is extracted as the variable P (S43), the object generating section 111 executes the width calculation processing with respect to the variable Y2 (YES in S44, and S45). Hereinafter, the width calculation processing of the variable P will be described.

Width Calculation Processing of Variable P

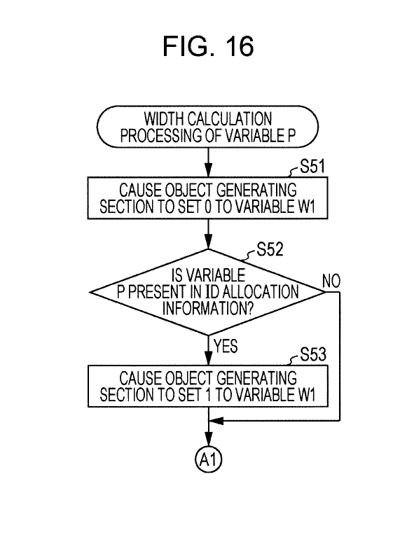

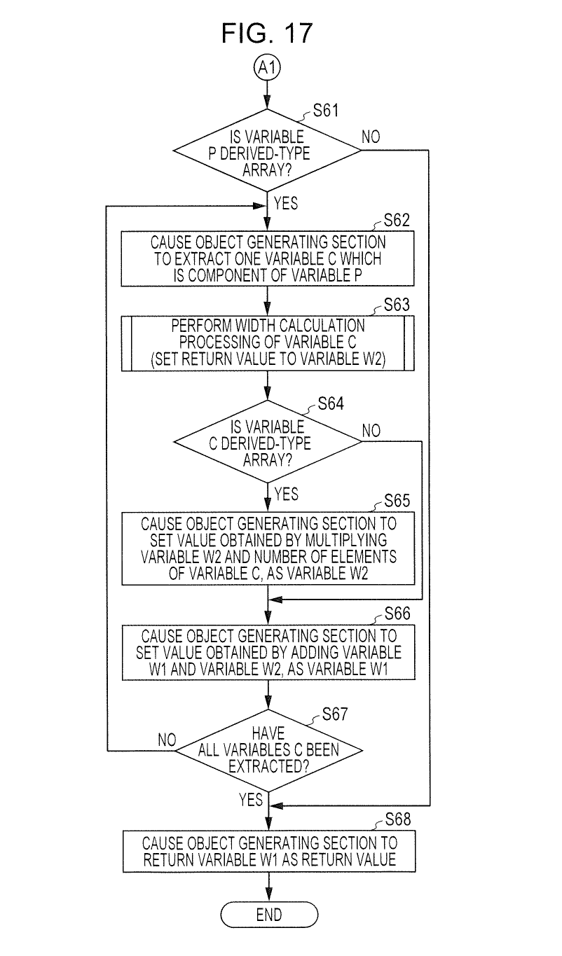

FIGS. 16 and 17 are views describing the width calculation processing of the variable P. Hereinafter, description will be given on the assumption that when the object generating section 111 executes the width calculation processing, a variable W1 and a variable W2 are used as variables storing values temporarily.

The object generating section 111 sets “0” to the variable W1 (S51). In a case where the variable P is present in the ID allocation information 133 (NO in S52), the object generating section 111 sets “1” to the variable W1 (S53). Meanwhile, in a case where the variable P is not present in the ID allocation information 133 (NO in S52), the object generating section 111 does not execute the processing of S53.

Specifically, in a case where the variable P is the array X2, the array X2 is not present in the ID allocation information 133 (NO in S52). Accordingly, in this case, the object generating section 111 does not perform the processing of S53. Therefore, “0” is set to the variable W1 (S51).

Next, in a case where the variable P is the derived-type array (YES in S61), as illustrated in FIG. 17, the object generating section 111 extracts a variable C which is a component of the variable P, and executes the width calculation processing of the extracted variable C (S62 and S63).

Subsequently, in a case where the variable C extracted through the processing of S62 is the derived-type array (YES in S64), the object generating section 111 sets a value obtained by multiplying the return value (the variable W2) in the processing of S63 (the width calculation processing of the variable C) and the number of elements of the variable C, as the variable W2 (S65). Meanwhile, in a case where the variable C extracted in S62 is not the derived-type array (NO in S64), the object generating section 111 does not execute the processing of S65.

Thereafter, the object generating section 111 sets a value obtained by adding the variable W1 and the variable W2, as the variable W1 (S66). In the processing of S62, in a case where extraction of all of the variables C is completed (YES in S67) or in a case where the variable P is not the derived-type array (NO in S61), the object generating section 111 returns the value stored in the variable W1, as the return value, thereby ending the width calculation processing of the variable P (S68).

Meanwhile, in a case where extraction of all of the variables C is not completed (NO in S67), the processing after S62 is executed again.

Specifically, the array X2 is the derived-type array. Accordingly, in a case where the variable P extracted through the processing of S43 is the array X2, the object generating section 111 extracts the variable Y2 which is a component of the array X2, as the variable C (YES in S61, and S62). After the processing of S62, the object generating section 111 executes the width calculation processing with respect to the variable C (S63). Hereinafter, description will be given regarding the width calculation processing in a case where the variable C is the variable Y2.

Width Calculation Processing in Case where Variable C is Variable Y2

The ID allocation information 133 illustrated in FIG. 21 includes information of the variable Y2 (information of which “item number” is “1”). Accordingly, the object generating section 111 sets “1” to the variable W1 (YES in S52, and S53). The variable Y2 is the derived-type array (YES in S61). Accordingly, the object generating section 111 extracts the variable Z2 which is a component of the variable Y2, and executes the width calculation processing of the variable Z2 (S62 and S63). Hereinafter, description will be given regarding the width calculation processing in a case where the variable C is the variable Z2.

Width Calculation Processing in Case where Variable C is Variable Z2

The ID allocation information 133 illustrated in FIG. 21 includes information of the variable Z2 (information of which “item number” is “2”). Accordingly, the object generating section 111 sets “1” to the variable W1 (YES in S52, and S53). The variable Z2 is not the derived-type array (NO in S61). Accordingly, the object generating section 111 sets “1” which is the value set to the variable W1, as the return value, thereby ending the width calculation processing of the variable Z2 (S68).

Returning to the width calculation processing of the variable Y2, the object generating section 111 sets “1” which is the return value in the width calculation processing of the variable Z2, with respect to the variable W2 (S63). The variable Z2 is not the derived-type array (NO in S64). Therefore, the object generating section 111 does not execute the processing of S65. Thereafter, the object generating section 111 sets “2” which is the value obtained by adding “1” set to the variable W1 and “1” set to the variable W2, with respect to the variable W1 (S66).

Here, in addition to the variable Z2, the array V2 is a component of the variable Y2. Accordingly, the object generating section 111 executes the processing after S62 again (NO in S67).

Specifically, the object generating section 111 extracts the array V2 which is a component of the variable Y2, and executes the width calculation processing of the array V2 (S62 and S63). Hereinafter, description will be given regarding the width calculation processing in a case where the variable C is the array V2.

Width Calculation Processing in Case where Variable C is Array V2

The ID allocation information 133 illustrated in FIG. 21 includes information of the array V2 (information of which “item number” is “3”). Accordingly, the object generating section 111 sets “1” to the variable W1 (YES in S52, and S53). The array V2 is not the derived-type array (NO in S61). Therefore, the object generating section 111 sets “1” which is the value set to the variable W1, as the return value, thereby ending the width calculation processing of the array V2 (S68).

Returning to the width calculation processing of the variable Y2, the object generating section 111 sets “1” which is the return value in the width calculation processing of the array V2, with respect to the variable W2 (S63). The array V2 is not the derived-type array (NO in S64). Therefore, the object generating section 111 does not execute the processing of S65. Thereafter, the object generating section 111 sets “3” which is the value obtained by adding “2” set to the variable W1 and “1” set to the variable W2, with respect to the variable W1 (S66).

Here, the variable Z2 and the array V2 which are the components of the variable Y2 are all extracted (YES in S67). Accordingly, the object generating section 111 sets “3” which is the value set to the variable W1, as the return value, thereby ending the width calculation processing of the variable Y2 (S68).

Returning to FIG. 15, the object generating section 111 sets the return value in the width calculation processing of the variable Y2, with respect to “width” of the variable P in the ID width information 134 (S45). In the processing of S46, in a case where it is determined that extraction of all of the variables P is completed (YES in S46), the object generating section 111 determines whether or not extraction of all of the first variables is completed (S47). As a result thereof, in a case where extraction of all of the first variables is completed (YES in S47), the object generating section 111 ends the processing of S22.

Meanwhile, in the processing of S46, in a case where it is determined that extraction of all of the variables P is not completed (NO in S46), the object generating section 111 executes the processing after S43 again. In addition, in a case where extraction of all of the first variables is not completed (NO in S47), the object generating section 111 executes the processing after S41 again.

Specifically, in a case where the first variable extracted through the processing of S41 is the array X2, as indicated by the underlined portion in FIG. 24, the object generating section 111 sets “3” which is the return value in the width calculation processing of the variable Y2, with respect to “width” of information (information of which “item number” is “1”) in which “first variable” of the ID width information 134 is “C2%X2” (S45, and YES in S46).

Thereafter, the object generating section 111 individually executes the processing of S22 in a case where the variable Z2 is extracted as the first variable, and the processing of S22 in a case where the array V2 is extracted as the first variable (NO in S47). Here, the variable Z2 and the array V2 are not the derived-type array (NO in S44, and YES in S47). Therefore, the width calculation processing of the variable Z2 and the width calculation processing of the array V2 are not executed. Accordingly, as illustrated in FIG. 24, the object generating section 111 can specify “3” as the number of components in each element of the array X2.

Returning to FIG. 13, the object generating section 111 prepares the ID allocation information 133 based on the first variable extracted through the processing of S21, and the ID width information 134 calculated through the processing of S22 (S23). Hereinafter, the details of the processing of S23 will be described.

Details of Processing of S23

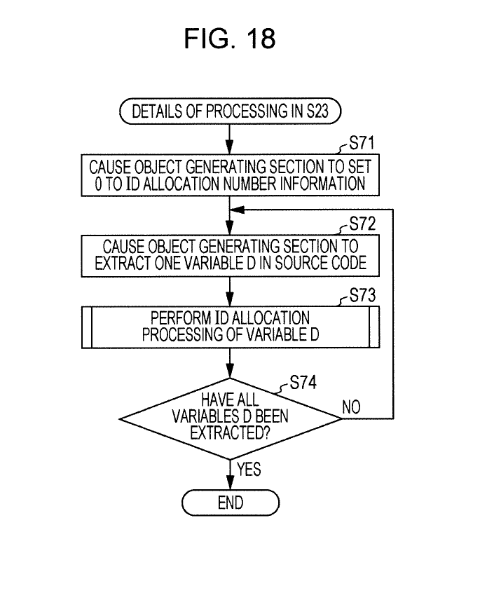

FIG. 18 is a view describing the details of the processing of S23. First, the object generating section 111 sets “0” to the ID allocation number information 135 (S71). The ID allocation number information 135 is information indicating the number of variables in which allocation of ID is completed. Hereinafter, a specific example of the ID allocation number information 135 will be described.

Specific Example of ID Allocation Number Information

FIGS. 25, 27, and 29 views describing specific examples of the ID allocation number information 135. The ID allocation number information 135 illustrated in FIGS. 25, 27, and 29 has “item number” for identifying each piece of information included in the ID allocation number information 135, and “ID” indicating the number of variables to which ID is allocated by the object generating section 111, as items.

Specifically, in the processing of S71, as illustrated in FIG. 25, the object generating section 111 sets “0” to “ID” which is information of which “item number” is “1”.

Returning to FIG. 18, the object generating section 111 extracts one variable (hereinafter, will also be referred to as a variable D) described in the source code 331 (S72). Here, for example, the variable D may be only the variable which itself does not become a component of a different variable. Accordingly, in a case of the source code 331 illustrated in FIG. 2, the coarray C1 and the coarray C2 correspond to the variable D. Thereafter, the object generating section 111 executes processing for allocating ID to the variable D and the components of the variable D (hereinafter, will also be referred to as ID allocation processing) (S73). Hereinafter, the ID allocation processing of the variable D will be described.

ID Allocation Processing of Variable D

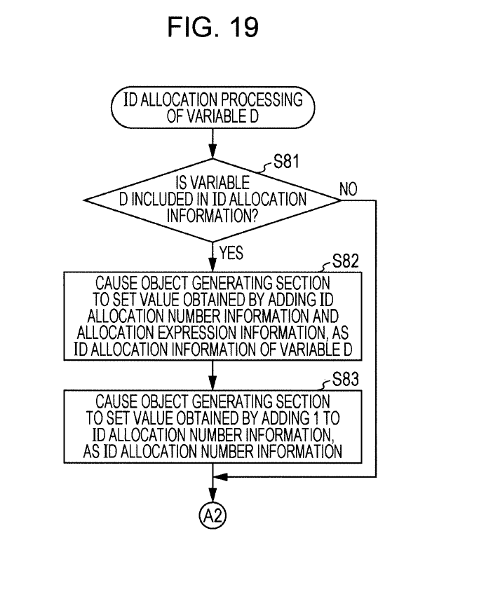

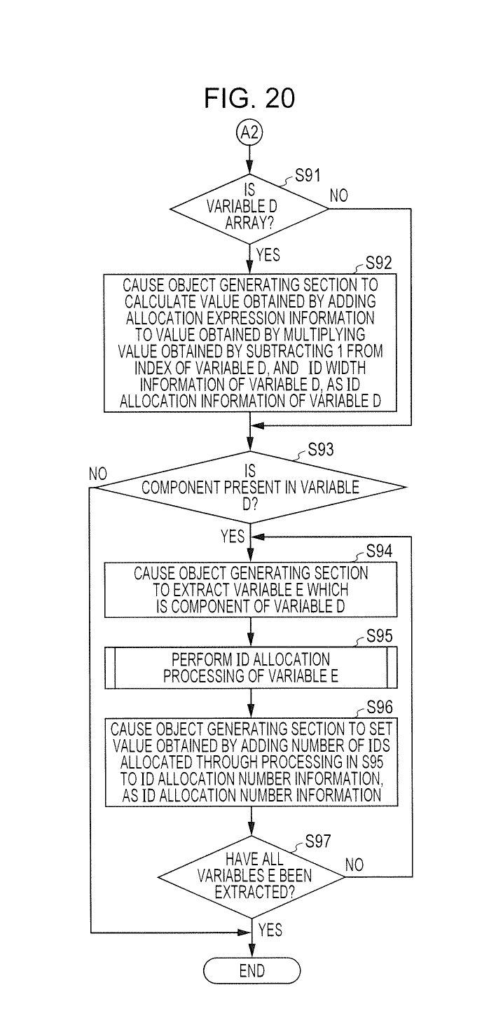

FIGS. 19 and 20 are views describing the ID allocation processing of the variable D. First, the object generating section 111 determines whether or not the variable D is included in the ID allocation information 133 (S81). In a case where it is determined that the variable D is included in the ID allocation information 133 (YES in S81), the object generating section 111 sets a value obtained by adding the ID allocation number information 135 and the ID allocation expression information 136, as the ID allocation information 133 of the variable D (S82). The ID allocation expression information 136 is information for indicating an expression which specifies the ID of a variable which is a component of the variable D based on the index of an array, in a case where the array is included in the component of the variable D. The specific example of the ID allocation expression information 136 will be described later.

The object generating section 111 sets the value obtained by adding “1” to the ID allocation number information 135, as new ID allocation number information 135 (S83).

Subsequently, as illustrated in FIG. 20, in a case where the variable D is an array (YES in S91), the object generating section 111 calculates a value obtained by adding the ID allocation expression information 136 to a value obtained by multiplying a value obtained by subtracting “1” from the index of the variable D and the ID width information 134 of the variable D, as the ID allocation information 133 of the variable D (S92). Meanwhile, in a case where the variable D is not an array (NO in S91), the object generating section 111 does not execute the processing of S92.

Thereafter, in a case where a component is present in the variable D (YES in S93), the object generating section 111 extracts a variable E which is a component of the variable D, and executes the ID allocation processing of the extracted variable E (S94 and S95). Moreover, the object generating section 111 sets a value obtained by adding the number of ID allocated through the processing of S95 to the ID allocation number information 135, as the ID allocation number information 135 (S96). In a case where extraction of all of the variables E is completed (YES in S97), the object generating section 111 ends the ID allocation processing of the variable D. Meanwhile, in a case where no component is present in the variable D (NO in S93), the object generating section 111 does not execute the processing S94 to S97. In addition, in a case where extraction of all of the variables E is not completed (NO in S97), the object generating section 111 executes the processing after S94 again.

Returning to FIG. 18, in a case where extraction of all of the variables D is completed (YES in S74), the object generating section 111 ends the processing of S23. Meanwhile, in a case where extraction of all of the variables D is not completed (NO in S74), the object generating section 111 executes the processing after S72 again.

Specifically, in the source code 331 illustrated in FIG. 2, the object generating section 111 extracts the coarray C1 as the variable D, and executes the ID allocation processing of the coarray C1 (S72 and S73). In this case, the components of the coarray C1 and the coarray C1 are not included in the ID allocation information 133 (NO in S81). Accordingly, the object generating section 111 does not execute the processing of S82 with respect to the components of the coarray C1 and the coarray C1. In other words, the object generating section 111 does not allocate ID to the components of the coarray C1 and the coarray C1.

Next, the object generating section 111 extracts the coarray C2 as the variable D, and executes the ID allocation processing with respect to the coarray C2 (NO in S74, S72, and S73).

Here, the ID allocation information 133 does not include the coarray C2 (NO in S81). In addition, the coarray C2 is not an array (NO in S91). Meanwhile, a component is present in the coarray C2 (YES in S93). Accordingly, the object generating section 111 extracts the array X2 which is a component of the coarray C2, and executes the ID allocation processing with respect to the extracted array X2 (S94 and S95).

In this case, the ID allocation information 133 does not include the array X2 (NO in S81). Meanwhile, the array X2 is an array (YES in S91). In addition, as illustrated in FIG. 24, “3” is set to “width” of information (information of which “item number” is “1”) in which “first variable” of the ID width information 134 is “C2%X2. Accordingly, the object generating section 111 calculates “(index of array X2−1)*3” as the ID allocation expression information 136 (S92).

Thereafter, the object generating section 111 extracts the variable Y2 which is a component of the array X2, and executes the ID allocation processing of the extracted variable Y2 (YES in S93, S94, and S95).

In this case, the ID allocation information 133 includes the variable Y2 (YES in S81). In addition, the ID allocation number information 135 is “0”. Accordingly, the object generating section 111 calculates “(index of array X2−1)*3” which is the value obtained by adding “0” of the ID allocation number information 135 and “(index of array X2−1)*3” of the ID allocation expression information 136 (S82). As indicated by the underlined portion in FIG. 26, the object generating section 111 sets “(index of array X2−1)*3” to “ID” of information (information of which “item number” is “1”) in which “first variable” of the ID allocation information 133 is “C2%X2%Y2”.

Subsequently, as indicated by the underlined portion in FIG. 27, the object generating section 111 sets “1” which is the value obtained by adding “1” to “0” (the ID allocation number information 135), with respect to “ID” of the ID allocation number information 135 (S83). Thereafter, since the variable Y2 is not an array, the object generating section 111 extracts the variable Z2 which is a component of the variable Y2, and executes the ID allocation processing with respect to the extracted variable Z2 (NO in S91, YES in S93, S94, and S95).

In this case, the ID allocation information 133 includes the variable Z2 (YES in S81). In addition, the ID allocation number information 135 in the ID allocation processing with respect to the variable Y2 is “1”. The ID allocation expression information 136 in the ID allocation processing with respect to the variable Y2 is “(index of array X2−1)*3”. Accordingly, the object generating section 111 calculates “(index of array X2−1)*3+1” which is a value obtained by adding “1” of the ID allocation number information 135 and “(index of array X2−1)*3” of the ID allocation expression information 136. As indicated by the underlined portion in FIG. 28, the object generating section 111 sets “(index of array X2−1)*3+1” to “ID” of information (information of which “item number” is “2”) in which “first variable” of the ID allocation information 133 is “C2%X2%Y2%Z2” (S82).

The variable Z2 is not an array and includes no component (NO in S91, and NO in S93). Accordingly, the object generating section 111 ends the ID allocation processing with respect to the variable Z2 (YES in S97).

Returning to the ID allocation processing of the variable Y2, the object generating section 111 calculates “2” which is a value obtained by adding “1” which is the number of ID allocated through the ID allocation processing with respect to the variable Z2, and “1” which is the ID allocation number information 135 in the ID allocation processing with respect to the variable Y2. As indicated by the underlined portion in FIG. 29, the object generating section 111 sets the calculated value of “2” as the ID allocation number information 135 in the ID allocation processing with respect to the variable Y2 (S96).

Thereafter, the object generating section 111 extracts the array V2 which is a component of the variable Y2, and executes the ID allocation processing with respect to the extracted array V2 (NO in S97, S94, and S95).

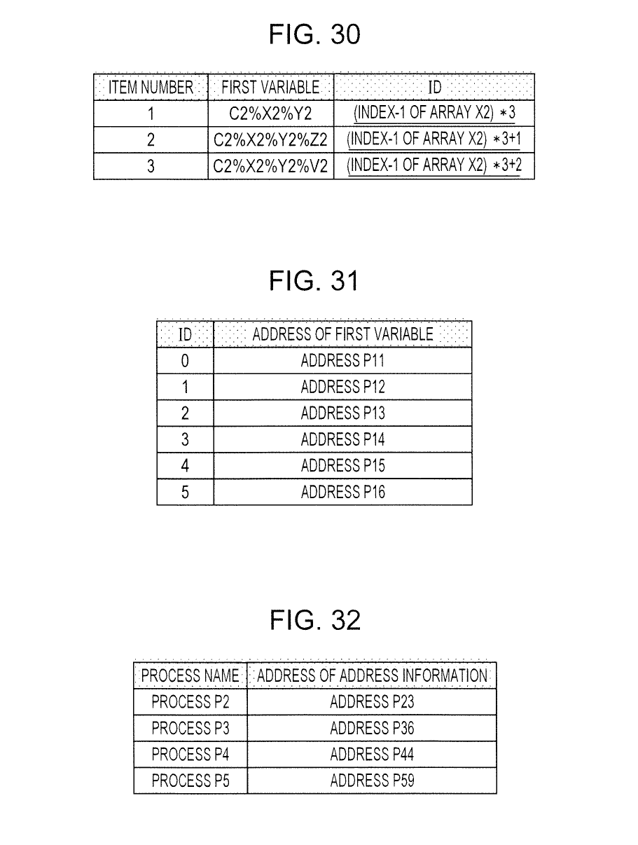

In this case, the ID allocation information 133 includes the array V2 (YES in S81). In addition, the ID allocation number information 135 in the ID allocation processing with respect to the variable Y2 is “2”. The ID allocation expression information 136 in the ID allocation processing with respect to the variable Y2 is “(index of array X2−1)*3”. Accordingly, the object generating section 111 calculates “(index of array X2−1)*3+2” which is a value obtained by adding “2” of the ID allocation number information 135 and “(index of array X2−1)*3” of the ID allocation expression information 136. As indicated by the underlined portion in FIG. 30, the object generating section 111 sets “(index of array X2−1)*3+2” to “ID” of information (information of which “item number” is “3”) in which “first variable” of the ID allocation information 133 is “C2%X2%Y2%V2” (S82).

Here, since the array V2 is an array (YES in S91), the object generating section 111 executes the processing of S92 through the ID allocation processing with respect to the array V2. However, in the successive processing, the object generating section 111 does not use the ID allocation information 133 updated through the processing of S92. Thus, description thereof will be omitted.

The array V2 includes no component. Therefore, the object generating section 111 ends the ID allocation processing with respect to the array V2 (NO in S93).

Thereafter, the object generating section 111 ends the ID allocation processing with respect to the variable Y2 and the ID allocation processing with respect to the array X2, thereby ending the processing of S23 (YES in S74).

Returning to FIG. 12, the object generating section 111 generates the object 333 such that the address information 131 of the first storage domain 102a is prepared when the object 333 is executed (S13). Hereinafter, a specific example of the address information 131 will be described.

Specific Example of Address Information

FIG. 31 is a view describing the specific example of the address information 131 prepared when the object 333 is executed. The address information 131 illustrated in FIG. 31 has “ID” described in FIG. 21 and the like, and “address of first variable” indicating the address of the first variable in the first storage domain 102a described in FIG. 11, as items.

Specifically, in the address information 131 illustrated in FIG. 31, “address P11” is set to “address of first variable” of information of which “ID” is “0”. Description of other pieces of information in FIG. 31 will be omitted.

In other words, in a case of having access to the first variable of the process P1, for example, the process P2 refers to the ID allocation information 133 described in FIG. 30. Specifically, in a case of having access to the variable Z2 which is a component of the second element in the array X2 of the process P1, the process P2 refers to “(index of array X2−1)*3+1” which is set to “ID” of the information in which “C2%X2%Y2” is set to “first variable” of the ID allocation information 133. The value “2” is substituted for “the index of array X2”, thereby acquiring “4” as “ID”. Next, in the address information 131 described in FIG. 31, the process P2 acquires “address P15” with reference to “address of first variable” of information of which “ID” is “4”.

Accordingly, in the shared memory domains allocated to the process P1, the process P2 can have access to the memory domain of which the address is “address P15”. The process P2 can have access to the second element in the array X2 of the process P1.

The process P1 and the process P2 are processes generated by executing the same object 333. Accordingly, the alignment sequence of “address of first variable” in the address information 131 corresponding to each process coincides in each process.

Returning to FIG. 12, the object generating section 111 generates the object 333 such that the address of the storage domain (hereinafter, a second storage domain) of the address information 131 is notified so as to be shared with a different process when the object 333 is executed (S14). Hereinafter, a specific example of the address position information 132 will be described.

Specific Example of Address Position Information

FIG. 32 is a view describing the specific example of the address position information 132 prepared when the object 333 is executed. The address position information 132 illustrated in FIG. 32 has “process name” for identifying each process, as an item. In addition, the address position information 132 illustrated in FIG. 32 has “address of address information” indicating the address of the storage domain (for example, the storage domain in a different physical machine) of the address information 131 in each process, as an item.

Specifically, in the address position information 132 illustrated in FIG. 32, “address P23” is set to information in which “P2” is set to “process name”, as “address of address information”. Description of other pieces of information in FIG. 32 will be omitted.

In other words, the address position information 132 illustrated in FIG. 32 indicates that the processes P2, P3, P4, and P5 are present in addition to the process P1, as the processes generated by executing the object 333. When the object 333 is executed, the object executing section 112 acquires the address of the address information 131 corresponding to each of the processes from the processes P2, P3, P4, and P5, thereby preparing the address position information 132 illustrated in FIG. 32. Thereafter, for example, the object executing section 112 stores the prepared address position information 132 in the information storage domain 130.

Accordingly, when having access to a shared memory domain allocated to a different process, the object executing section 112 can have access to the address information 131 corresponding to a different process by referring to the address position information 132. In addition, when the object 333 is executed, the object executing section 112 is not desired to notify a different process of the address information 131 itself.

Returning to FIG. 12, in a case where the first variable in a different process is referred to in response to execution of the object 333, the object generating section 111 generates the object 333 such that the address information 131 corresponding to the first variable is referred to (S15). Accordingly, in a case where each process has access to the first variable in a different process, the object generating section 111 can have access thereto via the address information 131.

Thereafter, the object generating section 111 stores the object 333 generated through the processing S12 to S15 in the information storage domain 330 of the storage device 3 (S16).

Object Execution Processing

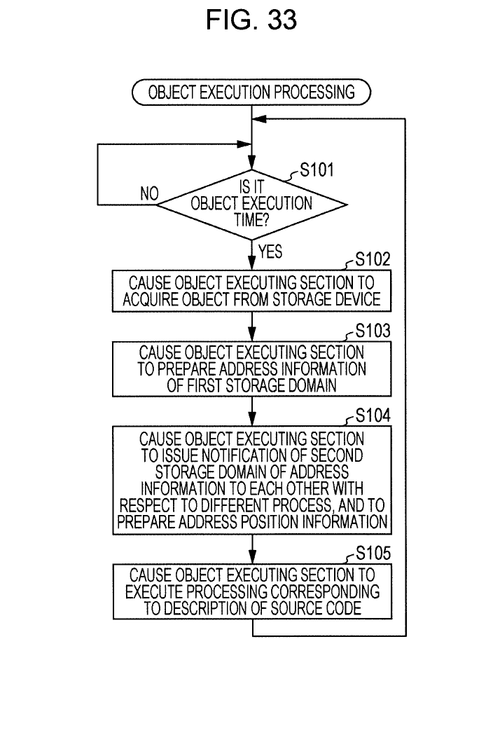

Next, description will be given regarding processing in which the object 333 according to the first embodiment is executed (hereinafter, will also be referred to as object execution processing). FIG. 33 is a flow chart describing the object execution processing, according to the first embodiment. Hereinafter, description will be given regarding a case where the physical machine 1 executes the object execution processing.

As illustrated in FIG. 33, the object executing section 112 of the physical machine 1 stands by until it is time to execute the object 333 (hereinafter, will also be referred to as an object execution time) (NO in S101). For example, the object execution time may be a time to execute the object 333 in information which is input to the service provider terminal 11.

Thereafter, in a case where it is the object execution time (YES in S101), the object executing section 112 acquires the object 333 from the information storage domain 330 of the storage device 3, thereby starting execution of the object 333 (S102).

The object executing section 112 prepares the address information 131 (S103). Specifically, for example, the object executing section 112 performs preparation of the address information 131 described in FIG. 31. The object executing section 112 stores the prepared address information 131 in the information storage domain 130.

Subsequently, the object executing section 112 issues notification of the address of the storage domain (the second storage domain) of the address information 131 so as to be shared with a different process (a process generated by executing the object 333), thereby preparing the address position information 132 (S104).

Specifically, the object executing section 112 transmits the address of the storage domain of the address information 131 with respect to a different process which starts an operation in a different physical machine. The object executing section 112 receives the address of the storage domain of the address information 131 from the different process which starts an operation in the different physical machine. Thereafter, for example, the object executing section 112 prepares the address position information 132 described in FIG. 32, based on the address of the storage domain of the address information 131 received from the different process.

Thereafter, the object executing section 112 executes the processing (the successive processing of the object 333) corresponding to the description in the source code 331 (S105).

The object executing section 112 may be configured to synchronize each of the processes when preparing each of the address information 131 and the address position information 132. In other words, for example, the object executing section 112 may be configured not to prepare the address position information 132 (the processing of S104) until the address information 131 corresponding to the multiple processes generated by executing the object 333 is all prepared.

In addition, the object executing section 112 may be configured to prepare the address information 131 and the address position information 132 based on each function described in the source code 331. In this case, the object executing section 112 may be configured to synchronize each of the processes based on each function when preparing each of the address information 131 and the address position information 132.

In this manner, the physical machine 1 has the object generating section 111 which generates the object 333 such that the address information of the first storage domain 102a storing a variable subjected to communication in multiple processes generated in response to execution of the object 333, that is, the first variable to which the storage domain is designated in response to execution of the object 333 is notified so as to be shared in the multiple processes when the object 333 is executed.

Accordingly, even in a case where a different process to be subjected to access is present in a different physical machine, the physical machine 1 can reduce the desired number of times of communication for access to the variable of the different process. Accordingly, the physical machine 1 can shorten the desired time for execution of the object.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

Note 1. An apparatus includes one or more memories; and one or more processors configured to be coupled to the one or more memories, wherein the one or more processors are configured to generate, through compiling a source code, an object program, execute the object program as multiple processes generated by execution of the object program, allocate a first storage domain in the one or more memories for each of the multiple processes, dynamically allocate a variable in the first storage domain for each of the multiple processes, notify multiple processes other than own process of address information of a content of the variable for each of the multiple processes.

Note 2. The apparatus according to note 1, wherein the first storage domain is a storage domain which can be referred to by each of the multiple processes.

Note 3. The apparatus according to note 1, wherein the one or more processors generate the object program in which a second storage domain that is a storage domain of the address information is notified so as to be shared in the multiple processes when the object program is executed.

Note 4. The apparatus according to note 1, wherein the one or more processors generate the object program that refers to the first storage domain indicated by the address information corresponding to the variable to be referred to, in a case where the variable of a different process included in the multiple processes is referred to in response to execution of the object program.

Note 5. The apparatus according to note 1, wherein the multiple processes are processes which are operated respectively by physical machines different from each other.

Note 6. The apparatus according to note 1, wherein the one or more processors generate the object program that prepares the address information when the object program is executed.

Note 7. A non-transitory, computer-readable recording medium having stored therein a program for causing a computer to execute a process, the process including generating, through compiling a source code, an object program, executing the object program as multiple processes generated by execution of the object program, allocating a first storage domain in one or more memories for each of the multiple processes, dynamically allocating a variable in the first storage domain for each of the multiple processes, notifying multiple processes other than own process of address information of a content of the variable for each of the multiple processes.

Note 8. The non-transitory, computer-readable recording medium which stores a compilation program according to note 7, wherein the first storage domain is a storage domain which can be referred to by each of the multiple processes.

Note 9. The non-transitory, computer-readable recording medium which stores a compilation program according to note 7, wherein a second storage domain which is a storage domain of the address information is notified so as to be shared in the multiple processes in notification processing.

Note 10. The non-transitory, computer-readable recording medium which stores a compilation program according to note 7, the processing further including referring to the storage domain indicated by the address information corresponding to the variable to be referred to, in a case where the variable of a different process included in the multiple processes is referred to.

Note 11. The non-transitory, computer-readable recording medium which stores a compilation program according to note 7, wherein the multiple processes are processes which are operated respectively by physical machines different from each other.

Note 12. The non-transitory, computer-readable recording medium which stores a compilation program according to note 7, the processing further including preparing the address information before the notification processing of the address information.

Note 13. A compilation method employed in a computer, the compilation method including generating, through compiling a source code, an object program, executing the object program as multiple processes generated by execution of the object program, allocating a first storage domain in one or more memories for each of the multiple processes, dynamically allocating a variable in the first storage domain for each of the multiple processes, notifying multiple processes other than own process of address information of a content of the variable for each of the multiple processes.

What is claimed is:

1. An apparatus, comprising:
one or more memories; and
one or more processors configured to be coupled to the one or more memories,
wherein the one or more processors are configured to
generate, through compiling a source code, an object program,
execute the object program as multiple processes generated by execution of the object program,
allocate a first storage domain in the one or more memories for each of the multiple processes,
allocate a variable in the first storage domain for each of the multiple processes,
notify multiple processes other than own process of address information of a content of the variable for each of the multiple processes.

2. The apparatus according to claim 1,
wherein the first storage domain is a storage domain which is referred to by each of the multiple processes.

3. The apparatus according to claim 1,
wherein the one or more processors generate the object program in which a second storage domain that is a storage domain of the address information is notified so as to be shared in the multiple processes when the object program is executed.

4. The apparatus according to claim 1,
wherein the one or more processors generate the object program that refers to the first storage domain indicated by the address information corresponding to the variable to be referred to, in a case where the variable of a different process included in the multiple processes is referred to in response to execution of the object program.

5. The apparatus according to claim 1,
wherein the multiple processes are processes which are operated respectively by physical machines different from each other.

6. The apparatus according to claim 1,
wherein the one or more processors generate the object program that prepares the address information when the object program is executed.

7. A non-transitory, computer-readable recording medium having stored therein a program for causing a computer to execute a process, the process comprising:
generating, through compiling a source code, an object program,
executing the object program as multiple processes generated by execution of the object program,
allocating a first storage domain in one or more memories for each of the multiple processes,
allocating a variable in the first storage domain for each of the multiple processes,
notifying multiple processes other than own process of address information of a content of the variable for each of the multiple processes.

8. The non-transitory, computer-readable recording medium which stores a compilation program according to claim 7,
wherein the first storage domain is a storage domain which can be referred to by each of the multiple processes.

9. The non-transitory, computer-readable recording medium which stores a compilation program according to claim 7,
wherein a second storage domain which is a storage domain of the address information is notified so as to be shared in the multiple processes in notification processing.

10. The non-transitory, computer-readable recording medium which stores a compilation program according to claim 7, the processing further comprising:
referring to the storage domain indicated by the address information corresponding to the variable to be referred to, in a case where the variable of a different process included in the multiple processes is referred to.

11. The non-transitory, computer-readable recording medium which stores a compilation program according to claim 7,
wherein the multiple processes are processes which are operated respectively by physical machines different from each other.

12. The non-transitory, computer-readable recording medium which stores a compilation program according to claim 7, the processing further comprising:
preparing the address information before the notification processing of the address information.

13. A compilation method employed in a computer, the compilation method comprising:
generating, through compiling a source code, an object program;
executing the object program as multiple processes generated by execution of the object program;
allocating a first storage domain in one or more memories for each of the multiple processes;
allocating a variable in the first storage domain for each of the multiple processes;
notifying multiple processes other than own process of address information of a content of the variable for each of the multiple processes.
